(19) United States
(12) Patent Application Publication
(10) Pub. No.: US 2015/0154514 A1
(43) Pub. Date: Jun. 4, 2015

(54) EVENT ORGANISING METHOD AND APPARATUS

(71) Applicant: iVVY HOLDINGS PTY LTD, Varsity Lakes (AU)

(72) Inventors: Lauren Deborah Hall, Tallai (AU); James Bruce Greig, Varsity lakes (AU)

(73) Assignee: IVVY HOLDINGS PTY LTD, Varsity Lakes (AU)

(21) Appl. No.: 14/541,122

(22) Filed: Nov. 13, 2014

(30) Foreign Application Priority Data
Nov. 14, 2013 (AU) AU2013904408

(51) Int. Cl. G06Q 10/02; G06Q 10/06

(52) U.S. Cl. CPC G06Q 10/02; G06Q 10/06

(57) ABSTRACT

A method and apparatus for booking a venue for an event using a networked computer environment is disclosed. The apparatus determines venue requirements and/or supplier requirements, determines venues matching the venue requirements by searching a database for venue details of multiple venues and/or determines and/or supplier requirements by searching a database for venue details of multiple suppliers. The apparatus determines venues matching the venue requirements by searching a database for venue details of multiple venues and/or determines suppliers matching the supplier requirements by searching a database for suppliers' details of multiple suppliers and provides an indication of available venues and/or suppliers to a display of a user interface device via a communications network. A determination of a selection of an available venue from a venue booking request and/or a selection of an available supplier from a supplier booking request is received from a user interface device via the communications network and the selected venue and/or suppliers are booked.

The present application claims the benefit of Australian Patent application number AU2013904408, filed on Nov. 14, 2013 the content of which are hereby incorporated by reference.

### BACKGROUND

The present invention relates to a method and apparatus for organising an event, including a method and apparatus for booking a venue, and a method and apparatus for booking suppliers.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The process of organising and booking events is generally performed in an Ad-Hoc manner. Typical industry standard for organising events such as conferences is to employ an event organiser who is knowledgeable in the process of organising the conference or event. The event organiser will typically utilise their own knowledge to prepare a program for the conference and then seek necessary venues and suppliers as required.

In this regard, venues typically maintain their own booking system and calendar. Accordingly, it is typical for an event organiser to have phone round a number of different venues, identify those that may have availability to host a conference, obtain quotes and then seek approval of these from the client before proceeding with bookings. This in turn creates a number of problems not least because of conference venues may be booked in the intervening time between an organiser obtaining a quote and a then obtaining approval from the client to proceed with the booking. Additionally, suitable venues can be difficult to identify and this largely requires inherent knowledge by the conference organiser in order to ensure an adequate venue is obtained.

Similar issues signed the booking of suppliers. In this regard, suppliers are considered to be any entity that is supplying a service associated with the conference, such as provision of food, entertainment, conference materials or the like. Again, booking of suppliers is typically performed on an Ad-Hoc basis.

As a result of the above issues, it is not generally possible for inexperienced individuals to easily organise a conference, meaning such processes are generally left to a small enclave of professional service suppliers. It will also be appreciated that similar issues extend to a wide range of events, such as concerts, business meetings, network functions or the like.

### SUMMARY

In one implementation an apparatus for booking a venue for an event using a networked computer environment is shown. The apparatus includes a memory containing instructions which when executed by an electronic processing device determine venue requirements, determine venues matching the venue requirements by searching a database for venue details of multiple venues, provide an indication of available venues to a display via a communications network, determine a selection of an available venue from a venue booking request received from a user interface device via the communications network, and book the selected venue by providing information regarding the selection of the available venues to a venue operator interface device.

In another implementation, a method for booking a venue for an event using a networked computer environment is shown the method for booking a venue for an event includes a networked computer environment using an electronic processing device. The method includes determining venue requirements, determining venues matching the venue requirements by searching venue details of multiple venues, providing an indication of available venues to a user interface device via the communications network, determining a selection of an available venue from a venue booking request received from the user interface device via the communications network, and booking the selected venue.

In a further implementation, an apparatus for booking a supplier for an event using a networked computer environment is disclosed. The apparatus has a memory containing instructions which when executed by an electronic processing device includes determining supplier requirements, determining suppliers matching the supplier requirements by searching supplier details of multiple suppliers, providing an indication of available suppliers to a user interface device via the communications network, determining selection of an available supplier from a supplier booking request received from the user interface device via the communications network, and booking the selected supplier.

In an additional implementation, an apparatus for booking a supplier for an event using a networked computer environment is disclosed. The apparatus organizing the event uses a networked computer environment. The apparatus includes a memory storing instructions which when executed by an electronic processing device determine event requirements, determine venue requirements from the event requirements, use the venue requirements to book a venue, determine supplier requirements from the event requirements, use the supplier requirements to book a supplier, provide venue and supplier booking confirmation to a user interface device via the communications network, and provide event information.

In another implementation, method for booking a supplier for an event using a networked computer environment is disclosed. The method for organizing an event in a networked computer environment uses an electronic processing device. The method includes determining event requirements in response to an indication received from a user interface device, determining venue requirements from the event requirements. The venue requirements include a venue location, an event volume, and an event date. The method uses the venue requirements to book a venue, determines supplier requirements from the event requirements, the supplier requirements including a supplier location, an event volume, and an event date. The method uses the supplier requirements to book a supplier by providing the determined supplier requirements to a supplier interface device. A venue and a supplier booking confirmation is provided to a user interface device via the communications network, and event information regarding the selection of the available venue is provided to a venue operator interface device while simultaneously providing the determined supplier requirements to the supplier interface device. In one implementation the selection of the available venue is provided to a venue operator interface device while simultaneously providing a) the determined supplier requirements to the supplier interface device, and b) the venue and the supplier booking confirmation to the user interface device.

The different forms of the invention and their respective features can be used independently, in conjunction or interchangeably.

### BRIEF DESCRIPTION OF THE DRAWINGS

An example of the present invention will now be described with reference to the accompanying drawings, in which:—

FIG. 1A is a flowchart of an example of a venue booking method;

FIG. 1B is a flowchart of an example of a supplier booking method;

FIG. 1C is a flowchart of an example of a method of organising an event;

FIG. 2 is a schematic diagram of an example of a distributed computer architecture;

FIG. 3 is a schematic diagram of an example of a processing system of FIG. 2;

FIG. 4 is a schematic diagram of an example of a computer system of FIG. 2;

FIG. 5 is a flowchart of an example of a process of registering a venue for a venue booking method;

FIGS. 6A and 6B are a flowchart of a specific example of a venue booking method;

FIGS. 6C and 6D are schematic diagrams of examples of user interfaces used in the venue booking method of FIGS. 6A and 6B;

FIG. 7 is a flowchart of a second specific example of a venue booking method; and,

FIGS. 8A and 8B are a flowchart of a specific example of a method of organising an event.

### DETAILED DESCRIPTION

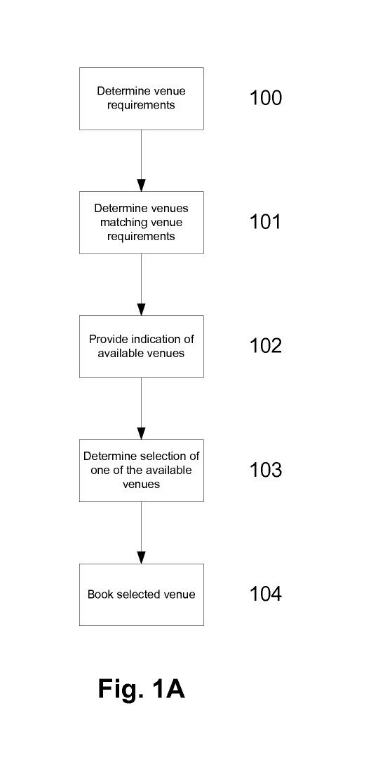

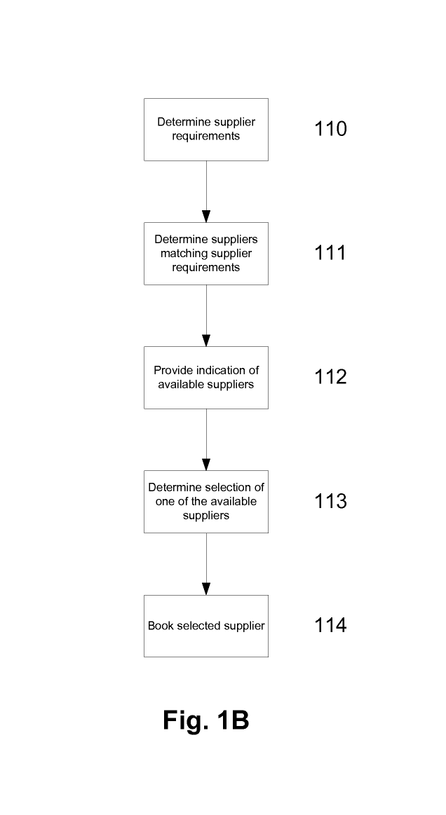

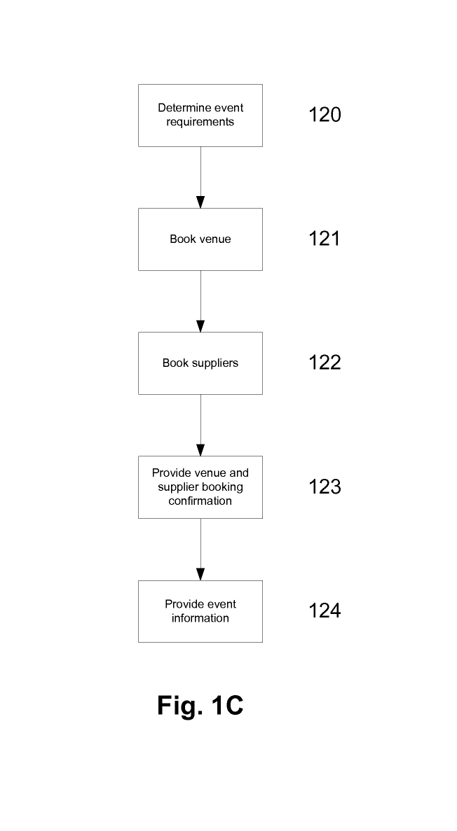

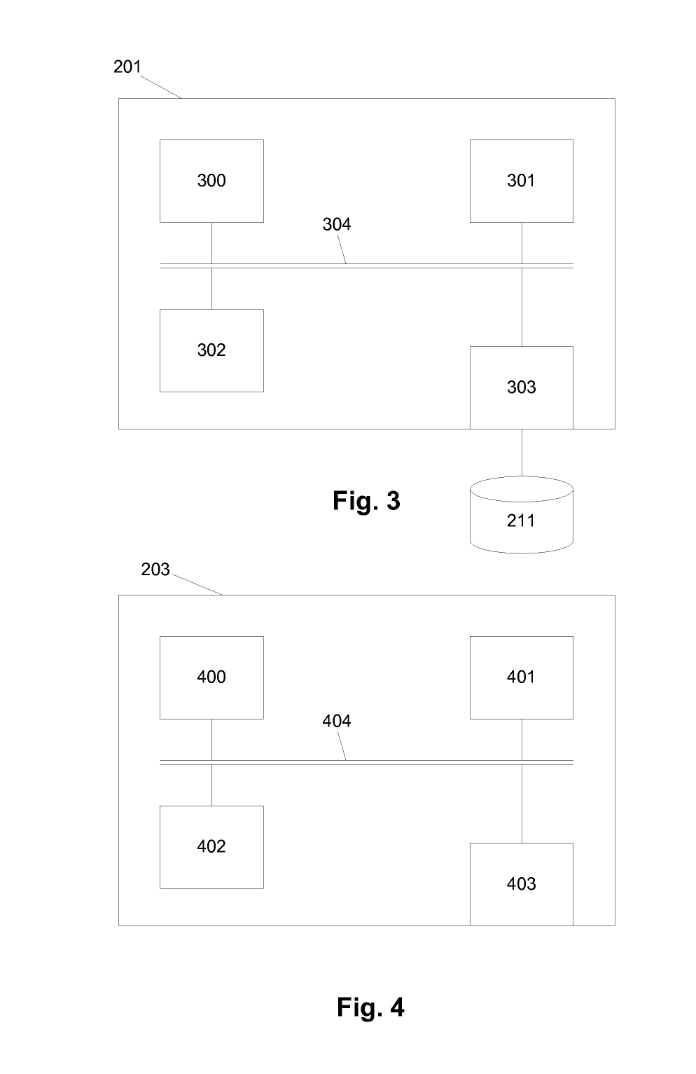

An example flowchart of a process for booking a venue for an event will now be described with reference to FIG. 1A. The flowchart of the process may be stored as instructions in a memory (See FIGS. 3-4) and may be executed by an electronic processing device (See FIGS. 3-4) using the at least one microprocessor described herein in connection with FIGS. 3-4.

In this example, it is assumed that the process is performed at least in part using an electronic processing device forming part of a processing system, which is in turn connected to one or more other processing or computer systems via a network architecture, as will be described in more detail below.

For the purpose of the example, the following terminology will be used. The term “event” is used to refer to any function that is to be organised, and that typically includes attendees attending a venue. Thus, it will be appreciated that the term event can include conferences, business meetings, concerts, exhibitions, shows, or the like. The term “venue” refers to any location capable of hosting an event and can include conference centres, hotels, function rooms, business meeting rooms, concert venues, room layout and/or type, or the like.

The term “user” refers to an entity such as an individual, company, or the like, that is interacting with the electronic processing device, for example to book a venue and/or organise an event. The term “venue operator” refers to an entity such as an individual, company, or the like, that is operating or otherwise managing a venue, including a venue owner or employee thereof. The term “venue operator interface device” refers to a device, such as an electronic processing device, that may be used by the venue operator. The term “supplier” refers to an entity such as an individual, company, or the like, that is providing supplies, such as catering, entertainment, food and/or beverages, menu items, equipment, such as tables, chairs, projectors, screens, staging equipment, computers, or the like, for use in an event. The term “supplier interface device” refers to a device, such as an electronic processing device (personal computer, personal desktop assistant, smart phone, laptop, etc.), that may be used by the supplier. The term “booking” refers to entering determined information desired by a user and in response to a request by a user, including but not limiting to an event, a venue, food and/or beverages, theme, accommodation, room layout or type, a date, a preferred supplier, preferred supplies into a log or database and making such determined information available to a venue operator (via a venue interface device) and supplier (via a supplier interface device). It will be appreciated that the above terms are for the purpose of illustration and are not intended to be limiting.

In this example, at step 100 the electronic processing device (See FIG. 3) determines venue requirements. The venue requirements typically include information such as a desired venue location, expected event volume, such as number of people expected to attend the event, and a desired event date. The venue requirements may be obtained in any appropriate manner and can be supplied by a user, for example by having the electronic processing device interpret user input commands provided via an input device, a user interface device, a device having a user interface, or communications network, receive venue requirements from a remote computer system, or can alternatively retrieve venue requirements from previously stored data, such as event requirements, as will be described in more detail below.

At step 101 the electronic processing device determines venues matching the venue requirements by searching venue details of multiple venues. In particular, the electronic processing device typically has access to venue details of multiple venues, which are stored in a database or other similar repository. The venue details set out information regarding the venue including the venue location, the capabilities of the venue, such as the number of people the venue can accommodate, and optionally a calendar of venue availability. The venue details may also optionally include other relevant information, such pricing information, limitations on venue use such as licensing permissions, or the like.

The electronic processing device uses the venue requirements as search terms to query the database and identify venues that meet the venue requirements. Thus, in one example, venue details for a number of venues are stored in a common repository or database, so that these can easily be accessed by the electronic processing device, allowing the electronic processing device to provide indications of any one or more of the venues that match the venue requirements.

At step 102 the electronic processing device provides an indication of available venues to a user or a user interface via a communications network. The indication may be in any appropriate form, but typically includes at least a list of the different available venues optionally with brief information regarding the venue, which can then be transferred to and displayed to the user or user interface via a computer system or the like. The user may also be able to request additional information regarding the venues if needed. In any event, this allows the user to view information regarding different available venues, so that they can assess the suitability of the venue for the particular event and make a selection of the venue that best meets the event's needs.

At step 103 the electronic processing device detects selection of one of the available venues from a booking request received from the user via the communications network. In this regard, the term booking request will be understood to include any indication that a booking is desired and this is not intended to be limiting. Selection and generation of the booking request may be achieved in any appropriate manner but could include for example selecting an embedded link within the list of available venues provided to the user.

At step 104 the electronic processing device operates to book the selected venue with a booking confirmation optionally being provided to the user. The booking may be achieved in any suitable manner but in one example, this involves having the electronic process add the booking into a calendar representing availability of the particular venue or providing booking information to a venue operator interface device. In one particular preferred example the calendar is maintained in a central database, as part of or associated with the venue details, so that the electronic processing device can enter details into the calendar and then prevent further conflicting bookings being made. In this regard, it will be appreciated that the term calendar is intended to refer to any data or other record that allows a determination of the time and date of availability of a venue, for example by specifying times at which the venue is booked, and is not intended to be limited to any particular format.

Accordingly, it will be appreciated that the above described process allows a user to access information regarding a number of suitable available venues that meet their requirements, and then perform a booking, all through interaction with a single central system, such as a website or booking system. This enables users to define requirements for the venue and then easily identify and book a venue, without needing to contact multiple different venues individually, thereby vastly simplifying the process of identifying and booking the venue. Furthermore, the ability to book the venue as part of the same process of identifying suitable available venues reduces the likelihood of intervening bookings being made while a user is assessing a venue's suitability. From the venue operator's perspective, this avoids the need to rely on user being able to search and identify their venue, thus reducing marketing requirements, whilst still ensuring bookings are obtained.

A similar process can also be performed in respect of booking suppliers for events, as will now be described in reference to FIG. 1B.

In this example, at step 110 the electronic processing device determines supplier requirements. The supplier requirements typically include information such as details of what suppliers are required, expected event volume, such as number of people expected to attend the event, a desired event date and location (venue). Again this may be achieved in accordance with user input commands for example by having the user submit via a user interface device requirements for the supplier via a communications network. Alternatively, this may be retrieved from event requirements that have been previously stored as will be described in detail below.

At step 111 the electronic processing device determines suppliers matching the supplier requirements by searching supplier details of multiple suppliers. In particular, the electronic processing device typically has access to supplier details of multiple suppliers, which are stored in a database or other similar repository. The supplier details set out information regarding the supplier including capabilities of the supplier including what they are able to supply and to how many people, locations to which they will supply, and optionally a calendar of supplier availability. The supplier details may also optionally include other relevant information, such as pricing information, or the like.

The electronic processing device uses the supplier requirements as search terms to query the database and identify suppliers that meet the supplier requirements. Thus, in one example, supplier details for a number of venues are stored in a common repository or database, so that these can easily be accessed by the electronic processing device, allowing the electronic processing device to provide indications of any one or more of the suppliers that match the supplier requirements. In one implementation, the supplies selected to match the supplier requirements may be a function or related to the venue. For example in a first venue may require (or be selected from) a first set of supplies, while another venue may require a second different set of supplies.

At step 112 the electronic processing device provides an indication of available suppliers to a user via a communications network. The indication may be in any appropriate form, but typically includes at least a list of the different available suppliers optionally with brief information regarding the supplier, which can then be transferred to and displayed to the user via a computer system or the like. The user may also be able to request via a user interface device additional information regarding the suppliers if needed. In any event, this allows the user to view information regarding different available suppliers, so that they can assess the suitability of the supplier for the particular event and make a selection of the supplier that best meets the event's needs.

At step 113 the electronic processing device detects selection of one of the available supplier from a supplier booking request received from the user interface device via the communications network. In this regard, the term booking request will be understood to include any indication that a booking is desired and this is not intended to be limiting. Selection and generation of the booking request may be achieved in any appropriate manner but could include for example selecting an embedded link within the list of available supplier provided to the user. The supplier booking request may also include an indication of the particular supplies required, although this will depend on the services provided by the supplier.

At step 114 the electronic processing device operates to book the selected supplier with a booking confirmation optionally being provided to the user via a display on the user interface device. In one implementation the supplier may be provided venue requirements and/or the selected venue. The booking may be achieved in any suitable manner but in one example, this involves having the electronic process add the booking into a calendar representing availability of the particular supplier or providing information regarding the booking to a supplier interface device. In one particular preferred example the calendar is maintained in a central database, as part of or associated with the supplier details, so that the electronic processing device can enter details into the calendar and then prevent further conflicting bookings being made. In one implementation, the supplier acknowledges the booking and the electronic processing device provides the acknowledgment to the user via network to the user interface device.

Accordingly, it will be appreciated that the above described process allows a user to access information regarding a number of suitable available suppliers that meet their requirements, and then perform a booking, all through interaction with a single central system, such as a website or booking system, thereby providing similar benefits to those outlined above with respect to venue booking.

It will also be appreciated that this process can be useful performed in conjunction with a venue booking process, thereby making it easy for users to automatically book both venues and suppliers substantially simultaneously by providing booking information to the venue operator interface device and a supplier interface device. In one implementation, the selected/determined venue and venue information can be provided to the supplier interface device while simultaneously providing the selected/determined supplies and supplier information can be provided to the venue interface device. Thus, the electronic processing device can be associated with a centralized repository that contains venue details and supplier details for a plurality of venues and suppliers. This allows a user to use a single source to search details of multiple venues, and/or suppliers and receive an indication of those that would be available, and make appropriate bookings.

This process may advantageously be performed as part of an event organising method and an example of this will now be described with reference to FIG. 1C.

In this example, at step 100 the electronic processing device determines event requirements. The event requirements typically include information such as a nature or type of event, a desired event location, an expected event volume, such as number of people expected to attend the event, a desired event date, details of required event supplies, as well as additional information such as a proposed event program, details of speakers, travel arrangements, accommodation requirements, or the like.

At step 121 the electronic processing device books a venue, at least partially in accordance with the event requirements. It will be appreciated that in one example, the venue booking is performed using the process of FIG. 1A, with the electronic processing device automatically determining the venue requirements from a subset of the event requirements.

At step 122 the electronic processing device books any required suppliers. Again the supplier booking process can be performed using the process of FIG. 1B, with supplier requirements again being obtained as a subset of the event requirements.

At step 123 the electronic processing device provides venue and supplier booking confirmations to the user interface device, via the communications network, and then also additionally provides event information at step 124. The event information may be of any appropriate form, depending on the nature of the event. For example, the event information could include a conference program or similar that is provided to conference attendees and/or conference organisers, to assist them in running the conference. The event information could be in the form of a meeting invite sent to meeting attendees informing them of the time and location of the meeting. The event information could also be adapted for publication, for example as part of a website associated with the event, allowing potential attendees to view details of the event. In a further example, the website could be further adapted to provide an integrated registration platform, allowing attendees to register to attend the event.

Accordingly, the above described event organisation process can be used to combine the venue and supplier booking, thereby allowing a single process to be performed to book all the needs for an event. The event organisation process can also integrate additional steps, such as guiding the user through defining of the event requirements, using an event organisation wizard or similar, which provides suggestions for particular types of event, as will be described in more detail below. Finally, the process can create event information, that can be provided to relevant parties, such potential event attendees, organisers or the like, thereby assisting with running of the event. Thus, it will be appreciated that the above described process can assist non-experienced individuals in organising events, without requiring any specialist knowledge.

A number of further features will now be described.

For the venue booking process, the electronic processing device typically requests venue requirements from a user via the communications network, the request including an indication of required venue requirements and receives venue requirements from the user via the communications network. This allows the electronic processing device to search for suitable venues using the venue requirements and determine the availability of the suitable venues using a venue calendar associated with each venue. The suitable venues are identified by comparing the venue requirements to venue details and determining suitable venues in accordance with the results of the comparison, although any suitable technique could be used.

The electronic processing device generates a list of available venues and transfers the list of available venues to the user via the communications network. This allows the electronic processing device to determine a user selection of one of the venues in accordance with user input commands received via the communications network.

The process may also be performed using a venue electronic processing device associated with a respective venue. In this case, this can correspond to a website host of a venue website, allowing users to book directly with venues. In this case, the venue electronic processing device generates a venue booking request for the respective venue in response to user input commands. The venue booking request is transferred to the electronic processing device, which confirms the respective venue is available and books the venue in response to a successful confirmation. Thus, this allows user to interact with the venue directly, with the venue then interacting with the electronic processing device administering the venue booking process to make the booking. This prevents conflicting bookings occurring, whilst still allowing venues to take bookings directly, as will be described in more detail below.

When booking the venue, the electronic processing device updates a calendar associated with the selected venue in accordance with the venue requirements. Once a venue is booked, the electronic processing device generates a venue booking confirmation and transfers the venue booking confirmation to the user via the communications network.

The electronic processing device is typically associated with a database that stores venue details for a plurality of venues, the venue details including at least one of a venue location, a venue size and a calendar indicative of venue availability.

The electronic processing device also allows venues to register with the system, during which, the electronic processing device receives venue details from a venue operator or a venue operator interface device via the communications network and stores the venue details in the database. In this case, the electronic processing device receives a venue register request from the venue operator interface device via the communications network, generates a venue details request and transfers the venue details request to the venue operator interface device via the communications network, the venue details being received in response the venue details request, allowing these to be added to the database.

It will be appreciated that similar processes can be performed in respect of booking suppliers, and that the term venue and supplier can therefore be used interchangeably in the above described processes and this will not therefore be described in any further detail.

In terms of event organisation, the electronic processing device is typically adapted to determine an event type, determines a template associated with respective event type, the template defining required event requirements for the respective event type and determine event requirements at least partially in accordance with the template. Thus, this allows templates to be used that define requirements for organizing different types of events, so that these can be used by the electronic processing system to prompt a user through an event organization process.

Thus, typically the electronic processing device determines user selection of one of a number of available event types in accordance with user input commands and then selects one of a number of predefined templates using the selected event type. This allows the electronic processing device to display a list of available event types to a user, so they can then select a type of event and progress through an event organization process, for example in the form of a wizard or the like.

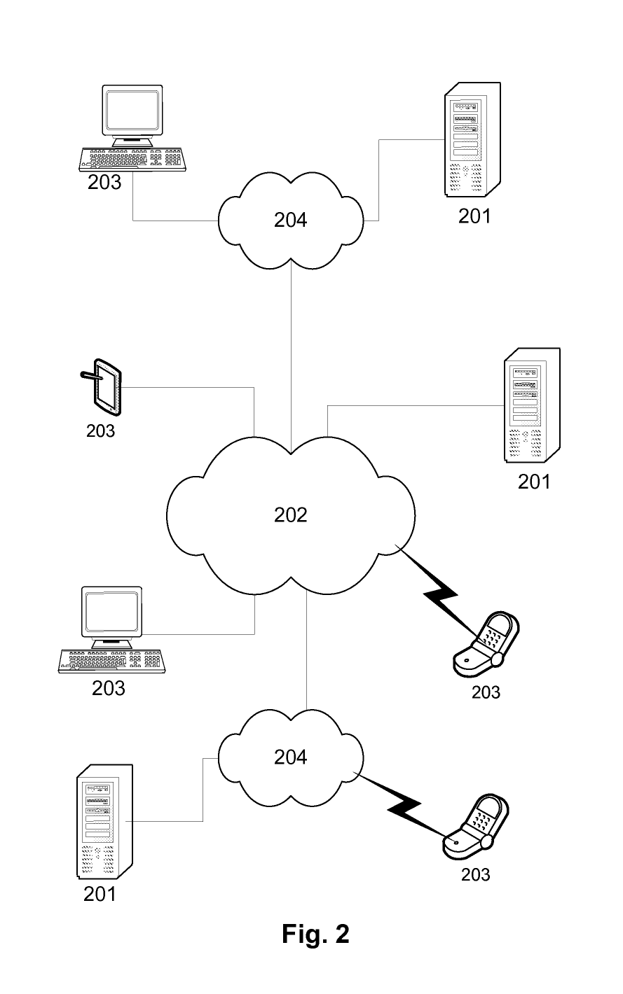

In one example, the above described processes are performed by one or more processing systems operating as part of a distributed architecture, an example of which will now be described with reference to FIG. 2.

In this example, the arrangement includes a number of processing systems 201 and computer systems 203 interconnected via one or more communications networks, such as the Internet 202, and/or a number of local area networks (LANs) 204. It will be appreciated that the configuration of the networks 202, 204 is for the purpose of example only, and in practice the processing and computer systems 201, 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

The use of separate terms “processing system” and “computer system” is for illustrative purposes and to enable distinction between different devices, optionally having different functionality. For example, the processing and computer systems 201, 203 could represent servers and clients respectively, as will become apparent from the following description. However, this is not intended to be limiting and in practice any suitable computer network architecture can be used.

An example of a suitable processing system 201 is shown in FIG. 3. In this example, the processing system 201 includes an electronic processing device, such as at least one microprocessor 300, a memory 301, an optional input/output device 302, such as a keyboard and/or display, and an external interface 303, interconnected via a bus 304 as shown. In this example the external interface 303 can be utilised for connecting the processing system 201 to peripheral devices, such as the communications networks 202, 204, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to perform required processes, such as communicating with other processing or computer systems 201, 203. Thus, actions performed by a processing system 201 are performed by the processor 300 in accordance with instructions stored as applications software in the memory 301 and/or input commands received via the I/O device 302, or commands received from other processing or computer systems 201, 203. The applications software may include one or more software modules, and may be executed in a suitable execution environment, such as an operating system environment, or the like.

Accordingly, it will be appreciated that the processing systems 201 may be formed from any suitable processing system, such as a suitably programmed computer system, PC, web server, network server, or the like. In one particular example, the processing systems 201 are standard processing system such as a 32-bit or 64-bit Intel Architecture based processing system, which executes software applications stored on non-volatile (e.g., hard disk) storage, although this is not essential. However, it will also be understood that the processing system could be or could include any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the computer systems 203 include an electronic processing device, such as at least one microprocessor 400, a memory 401, and an input/output device 402, such as a keyboard and/or display, and an external interface 403, interconnected via a bus 404 as shown. In this example the external interface 403 can be utilised for connecting the computer system 203 to peripheral devices, such as the communications networks 202, 204, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to perform required processes, for example to allow communication with other processing or computer systems 201, 203. Thus, actions performed by a processing system 203 are performed by the processor 400 in accordance with instructions stored as applications software in the memory 401 and/or input commands received from a user via the I/O device 402. The applications software may include one or more software modules, and may be executed in a suitable execution environment, such as an operating system environment, or the like.

Accordingly, it will be appreciated that the computer systems 203 may be formed from any suitable processing system, such as a suitably programmed PC, Internet terminal, lap-top, hand-held PC, smart phone, PDA, tablet, or the like. Thus, in one example, the processing system 300 is a standard processing system such as a 32-bit or 64-bit Intel Architecture based processing system, which executes software applications stored on non-volatile (e.g., hard disk) storage, although this is not essential. However, it will also be understood that the processing systems 203 can be any electronic processing device such as a microprocessor, microchip processor, logic gate configuration, firmware optionally associated with implementing logic such as an FPGA (Field Programmable Gate Array), or any other electronic device, system or arrangement.

It will also be noted that whilst the processing and computer systems 201, 203 are shown as single entities, it will be appreciated that this is not essential, and instead one or more of the processing and/or computer systems 201, 203 can be distributed over geographically separate locations, for example by using processing systems provided as part of a cloud based environment.

Examples of the above described method(s) will now be described in further detail. For the purpose of these examples, it is assumed that the process is administered by one or more of the processing systems 201, acting as event servers. Interaction by a user organising an event is via a user computer system 203, while venue operators and suppliers may also have their own processing or computer systems 201, 203 for interacting with the event server, and/or providing additional functionality, such as answering user enquiries, hosting of websites, or the like.

For the purpose of this example, it is assumed that the event server(s) 201 host webpages, allowing users to plan or otherwise organise events and book or register venues or suppliers, using a user computer system 203. The event server 201 allows venues and suppliers to register with the system, and create a profile including venue details or supplier details, which can be used in the booking processes. It will also be assumed that the user, venue operators or suppliers interact with event server 201 via a GUI (Graphical User Interface), or the like, presented on a respective computer system 203, or a venue operator interface device and in one particular example via a browser application that displays webpages hosted by the event server 201.

However, it will be appreciated that the above described configuration assumed for the purpose of the following examples is not essential, and numerous other configurations may be used. It will also be appreciated that the partitioning of functionality between the processing and computer systems 201, 203 may vary, depending on the particular implementation.

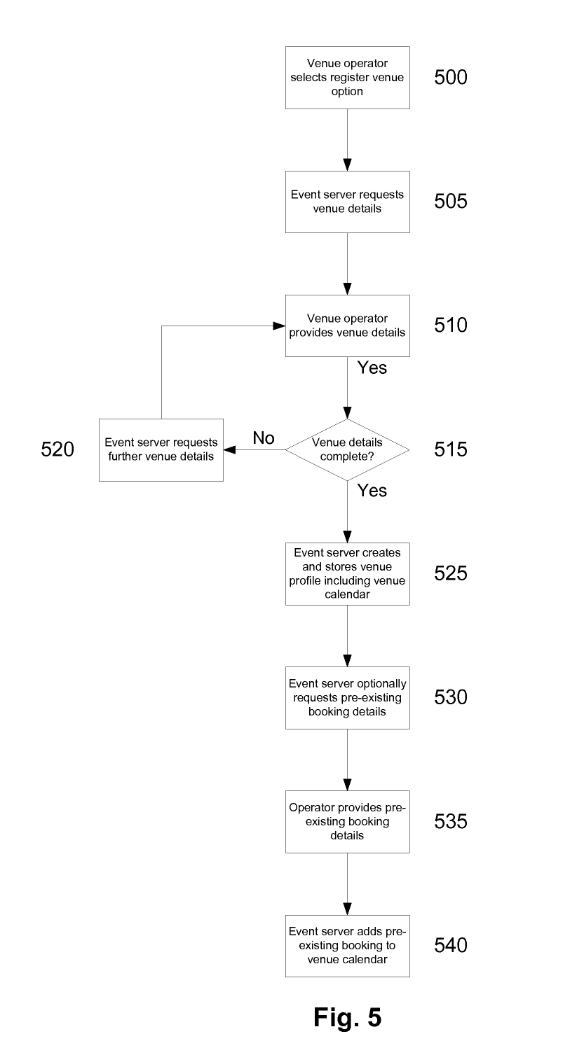

In order for a venue to be included in the venue booking process, it is typical for the venue to be registered with the event server, and an example of a process for registering a venue will now be described with reference to FIG. 5.

In this example, at step 500 a venue operator, such as a venue owner, employee or the like, selects a register venue option. This may be achieved in any suitable manner, but typically involves having the venue operator use a venue computer system 203 (or a venue operator interface device) to access a webpage hosted by the event server 201, with the register venue option being displayed on the webpage.

At step 505 the event server 201 detects selection of the register venue option and generates a venue details request, which is provided to the venue computer system 203 via the communications network. This typically involves having the event server 201 generate a webpage, including fields corresponding to required venue details, which then venue operator can then complete at step 510.

The nature of the venue details depend on the preferred implementation but typically would need to include information such as the address of the venue, details of any function rooms available at the venue, information regarding the capacity of the function rooms or venue, information regarding types of events that can be held, photos or other information regarding the venue, pricing information for different function rooms and event types, or the like. The information that is required is typically defined by the event server based on the nature of events that can be created and booked using the system. In this regard, it will be appreciated that using a field based approach ensures consistent information is gathered about each of the different venues that register with the system, making it possible to perform direct comparison between the venue details of each venue and venue requirements received from a user during a booking process.

As part of this process, the venue may also provide details of what information is required when making a booking. For example, as part of the booking process, a user may be required to specify any booking options associated with the booking, such as information regarding the format of the event, details of any sessions, food and beverage requirements, audio/visual requirements, accommodation requirements, room set-up or the like. Accordingly, the venue operator is able to define this when registering the venue, for example, through the use of suitable drop down menus, fields, or the like, so that the venue server 201 can ensure required information is provided to the venue during a booking process, as will be described in more detail below.

The venue operator may also be able to define pricing rules associated with different booking options. Thus, for example, the venue can define a basic cost per venue or function room, a cost per person and costs associated with different options, such as audio/video requirements, room set-up or the like. It will be appreciated that the rules can be complex, for example providing discounts in the event certain amounts of accommodation are booked by event attendees, or the like. The pricing rules can be stored as part of the venue profile, so that these can be used to determine a cost when the venue is booked, as will be described in more detail below.

The event server 201 receives the completed venue details from the venue operator interface device via the communication network, for example by having the venue operator select a submit option on the webpage, and determines whether the venue details are complete at step 515. If not the event server requests further venue details at step 520, for example by reloading the webpage and highlighting incomplete fields, allowing this process to be repeated until all necessary venue details are provided.

Once all necessary venue details are provided, at step 525 the event server 201 creates and stores a venue profile including the venue details and a venue calendar. The venue profile is typically stored in a database 211 associated with the event server 201, although this is not essential at any suitable repository may be used. However, it is important that the repository can be accessed by the event server 201 so that the event server 201 can automatically ascertain the suitability and availability of the venues for hosting particular events as will be described in more detail below.

At step 530 the event server optionally requests pre-existing booking details from the venue operator interface device, the pre-existing booking details being bookings for the venue that were already in place prior to the venue being registered with the system. In the event that this is performed the operator can provide pre-existing booking details at step 535, allowing these to be added into the venue calendar by the event server at step 540. This process can be performed by having the event server generate and display an appropriate webpage including fields that can be completed by the venue operator outlining details of pre-existing bookings, in a manner similar to determination the venue details as described above. This process can be used to ensure that when a venue registers with the system they can accommodate pre-existing bookings so that these do not conflict with new bookings made via the system.

Accordingly, it will be appreciated that the above described method allows a profile to be generated for each venue which is registered in the system. The profile includes venue details which allow events server to perform searching of the venues and identify venues that are suitable for hosting particular events, as well as identifying those suitable venues which are also available in the sense that they do not have a booking which would conflict with an event to be booked.

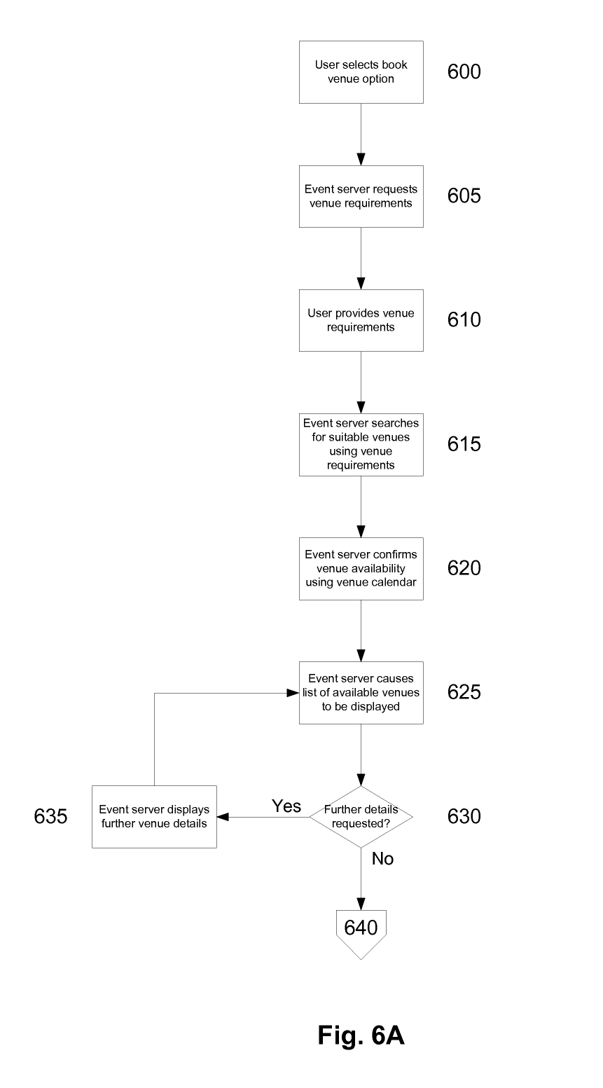

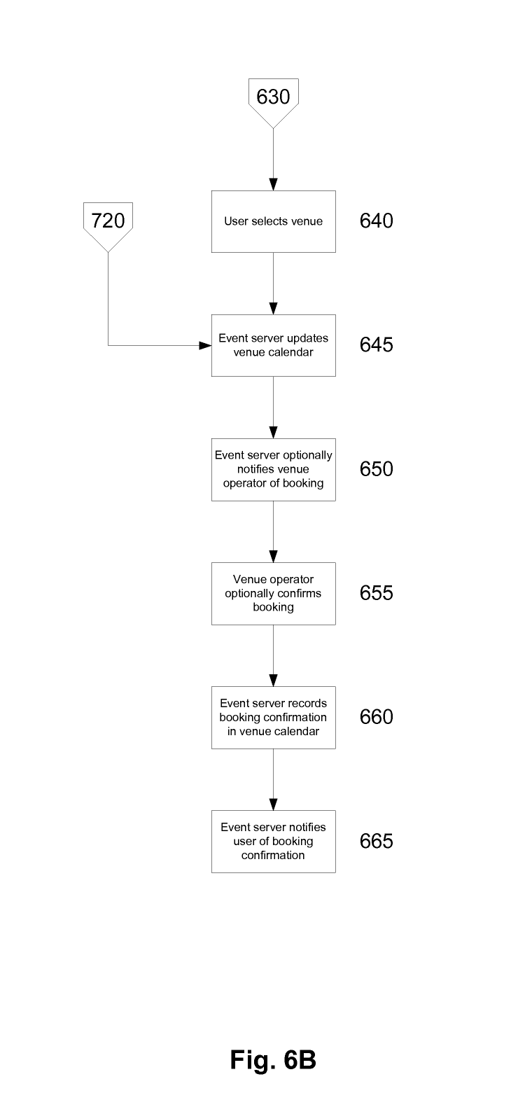

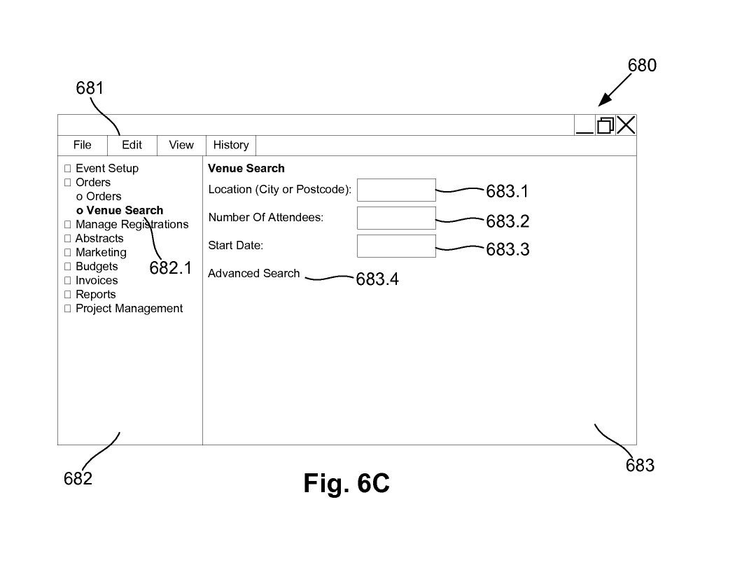

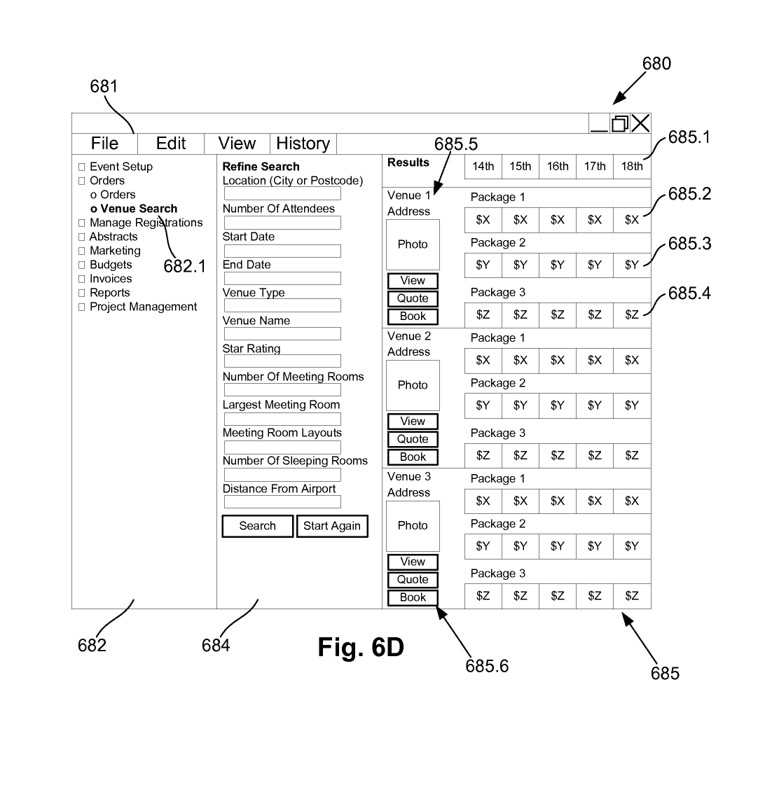

The process of booking a venue will now be described in more detail with reference to FIGS. 6A to 6D.

In this example, at step 600 the user selects a book venue option. This may be achieved in any appropriate manner but typically involves selecting a book venue option presented on a website hosted by the event server 201 and displayed on a user computer system 203. Alternatively, the venue booking may occur as part of a broader event planning process, as will be described in more detail below.

At step 605, the event server requests venue requirements from the user via the communications network, the request including an indication of required venue requirements, such as location, expected event volume and a desired event date. This may be achieved in any appropriate manner but in one example involves having the event server 201 generate a webpage including fields defining the required venue requirements, which is viewed and completed by the user using the user computer system 203. An example of a suitable webpage is shown in FIG. 6C and will now be described in more detail.

In this example, the user computer system displays a user interface 680 including menu options 681, for example forming part of a browser application. The browser application displays a webpage including an action tree 682 defining various actions that can be performed, which in this case shows that a “venue search” action 682.1 has been selected. A venue search window 683 is shown allowing a user to enter the venue requirements in respective fields, including a location field 683.1, a number of attendees' field 683.2 and a start date field 683.3, allowing a search of suitable venues to be determined. An advanced search option 683.4 may also be available if the user wishes to specify additional information, for example to define various other pluralities, numbers of meeting rooms and the like.

At step 610, the event server 201 receives the venue requirements from the user computer system 203, for example by having the user select to submit the completed requirements. It will also appreciated however that venue requirements could be determined in other manners, for example this could be achieved by having user input commands supplied directly to the events server 201, or using more general event requirements defining an event as will be described in more detail below.

At step 615, the event server 201 searches for suitable venues using the venue requirements. Thus, the event server 201 will typically query the database containing the venue details of the different venues and obtain a list of the different venues that match the requirements, and hence form suitable venues. Thus, the event server effectively compares the venue requirements to the stored venue details and then determines suitable venues in accordance with the results of the comparison. Thus, it will be checked whether the facilities of the venues as defined in the venue details meet or exceed the venue requirements defined by the user.

At step 620, the event server 201 uses the venue calendar associated with each suitable venue to determine the venue availability. As this is being performed at step 625, with the event server generating a listing of available venues which is then transferred to user, via the communications network, for example by providing a list of available venues as part of a webpage viewed via the processing system, as shown in FIG. 6D.

In this example, after an initial search has been performed, the event server displays a webpage including an action tree 682 defining various actions and in this case showing that a “venue search” action 682.1 has been selected. An advanced venue search window 684 is shown, including further fields to allow a user to define additional venue requirements, and hence restrict the number of suitable venues identified. The webpage further includes a results window 685, which displays details of suitable venues, together with an indication of their availability. In this regard, the results window includes date columns 685.1, with each venue result showing for available packages, the dates on which the package is available and the associated cost, as shown for three example packages at 685.2, 685.3, and 685.4. The results also typically include information regarding the venue 685.5, such as a name, address and photo, and input options 685.6, allowing a user to select to view further information, seek a more detailed quote or make a booking. It will be appreciated that the layout of the results is for the purpose of example only and is not intended to be limiting.

In any event, at step 630, the event server 201 determines if further details have been requested, in which case these are displayed at step 635. Thus, it will be appreciated that the user is able to browse through additional details of each of the suitable venues, and determine which of these best meets their requirements, and which are available at the required time.

Once a suitable available venue has been selected by the user, they can elect to book the venue at step 640, for example by having the user select a “book” input option provided in the results list window 685.

When a booking is requested, additional information may be required, for example to detail any requirements associated with the booking, such as information regarding the format of the event, details of any sessions, food and beverage requirements, audio/visual requirements, accommodation requirements, room set-up or the like. This can also include information regarding accommodation required for the event. In this regard, it will be appreciated that for events such as conferences, it is typical for organisers to pre-book a set number of rooms based on the expected number of attendees, with these being reserved for attendees at a predetermined rate.

It will be appreciated that this information can be obtained by the event server 201 by having this display a webpage including fields defining the required information, in a manner similar to requesting other information in the process, and this will not therefore be described in any further detail. In one example, the additional information requested may be defined by the venue, for example, during the registration process. This ensures that the event server 201 is able to request any information required by the venue in order to confirm the booking.

Additionally, as part of the booking request process, the user may be required to make a payment. This can be achieved using any appropriate process, as will be understood by persons skilled in the art. In one example, this can be achieved by hosting a webpage, allowing a user to supply appropriate payment details, such as a credit card or the like, allowing payment to be made.

As part of the payment process, the event server 201 may be required to use pricing rules defined by the venue operator and stored as part of the venue profile, as described above. The venue rules are used together with information supplied by the user during the booking process, such as the additional information described above, in order to calculate a cost of the requested booking. Thus, for example, the event server 201 can determine the number of rooms booked, the number of expected attendees, any additional requirements, and details of reserved rooms, allowing a total cost to be determined.

Once the booking is requested, and assuming required payments are required, at step 645 the events server 201 updates a calendar associated with the selected venue in the venue details. Thus the event server updates the venue calendar to include a booking for the respective event.

At step 650 the event server optionally sends a booking notification to notify the venue operator via a display on the venue operator interface device of the booking, for example by sending an email or the like, allowing the venue operator to optionally confirm the booking at step 655. The manner in which this is performed can vary depending on the preferred implementation, but will typically involve having the venue operator select a link via the venue operator interface device in the booking notification email, or the like. Providing venue operators with information regarding bookings allows venue operators, to check no conflict exists in making the booking, override or confirm any bookings as required, as well as manage internal processes for hosting the event, such as organising staffing and the like.

Additionally, and/or alternatively, venue operators can be provided with access to a dashboard or other similar information, that allows them to view details of bookings, as well as to administer an account, for example allowing them to update venue details, or the like.

At step 660, an event server records a booking confirmation in the venue calendar assuming this is already not being performed at step 645, and then notifies the user of the booking confirmation at step 665. In this regard, in response to a successful booking, the venue server 201 generates a venue booking confirmation and transfers the venue booking confirmation to the user via the communications network. This is typically performed by email or alternatively could be achieved by displaying confirmation webpage or combination thereof.

Accordingly, it will be appreciated that the above described process allows venues to be booked through a centralized website or the like hosted by the event server 201, which provides the ability to book any of the venues registered with the system.

Typically it is desirable for venues to be able to continue to receive bookings directly, in which case it is important to ensure that booking of the venue does not conflict with bookings that have been made via the above described process. Accordingly, in one example, the event server 201 is adapted to interface with a venue's existing booking processes. In one example, this is achieved by having a venue server 201 of the venue host a website including a widget which interfaces with the event server, allowing the event to be booked with the event server 201, in a manner similar to that described above, whilst still presenting users with the appearance of direct booking with the venue. In this regard, it will be appreciated that the website including the widget could be relate to an individual venue, or alternatively to a number of related venues, for example venues operated by a common company. Thus, for example, a chain of hotels could have a website for all hotels within the chain, with the widget allowing users to book any of those hotels, but not hotels of competing companies.

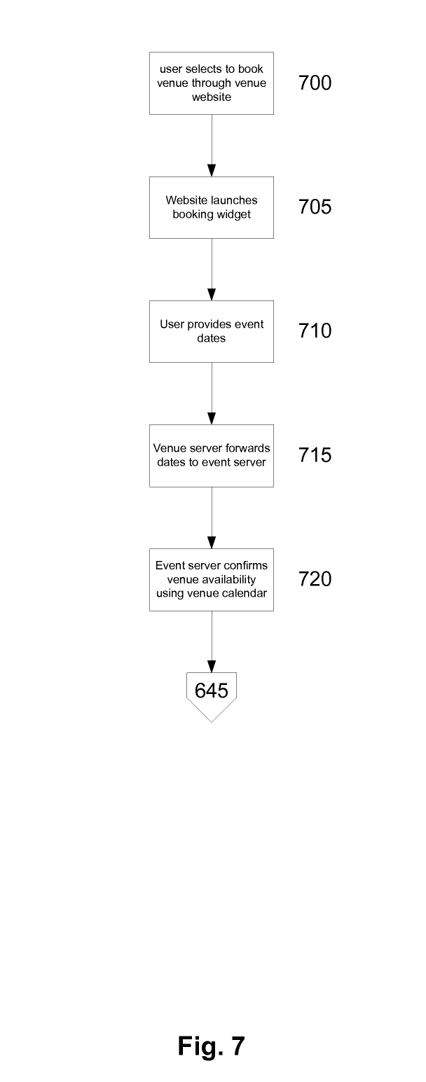

An example of this process will now be described with reference to FIG. 7.

In this example, at step 700 a user selects to book a venue by selecting a book venue option provided on a venue website hosted by a venue server 201. When the user selects via the user interface device the book venue option, the venue server 201 launches a venue booking widget at step 705, which is displayed on the venue website, allowing the user to enter relevant information, such as requested booking dates, and optionally select a particular venue, if the website relates to multiple venues.

Once the relevant dates the user wishes to book have been entered into the widget at step 710, the venue server 201 provides the dates, and optionally an indication of a selected venue to the event server 201, at step 715. The event server then checks the dates are available for the respective venue using the venue calendar stored as part of the venue details at step 720, and if so, proceeds to step 645 to book the venue using the process described above.

Thus, this allows the venue server 201 to host a widget on a website which in turn interfaces with the event server allowing the event server to perform a booking in the normal way. This avoids separate booking being made by the venue and event server, which could in turn result in conflicting bookings.

It will be appreciated that similar technique to the above described process can also be used for registering and booking supplies. Thus the process outlined in FIGS. 5 to 7 can be repeated for suppliers and this will not therefore be described in any detail. However, it will be appreciated that the term venue and supplier could be used interchangeably in the above examples.

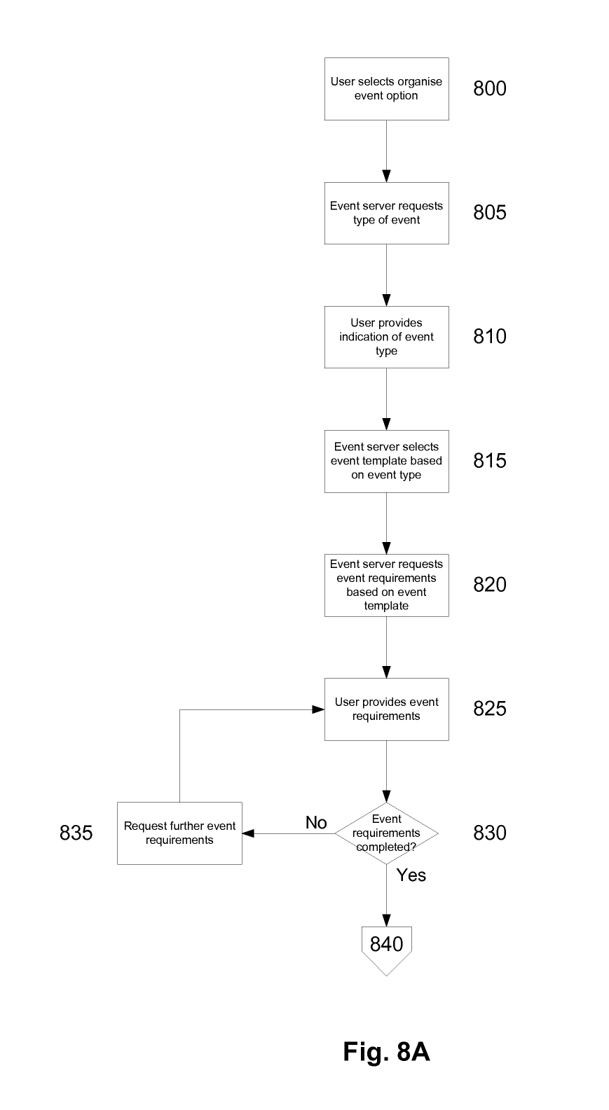

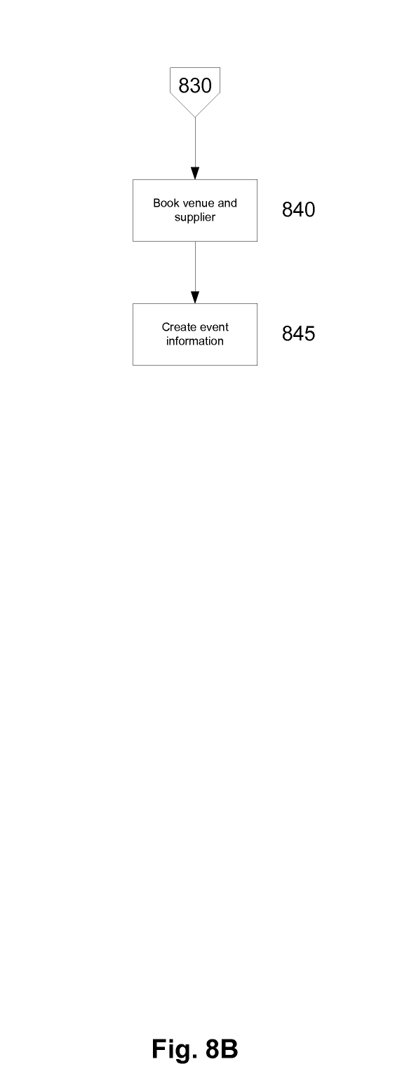

An example process for organising an event will now be described in more detail with reference to FIGS. 8A and 8B.

In this example, at step 100 the user selects an organise event option. This may be achieved in any appropriate manner but typically involves accessing an appropriate input on a website, such as using the actions tree 681 shown in FIG. 6C.

At step 805 the event server 201 requests a type of event, for example by displaying a drop down list of different types of event which the event server is configured to organise. This is important as different events typically have significantly different requirements and it is necessary for appropriate requirements to be collected each event. To achieve this, the event server 201 typically has access to a number of event templates that define different types of event. The event templates are previously defined by someone with an expertise in event organisation, and set out relevant information required in order to organise the respective type of event, including the typical structure and run format of the event, as well as an indication of the required associated event requirements. Thus, for a conference, the template will typically specify how the conference should be structured, how multiple different speakers should be scheduled, typical catering and entertainment options, or the like. The event templates are stored in the database 211, allowing these to be accessed by the event server 201 so that these can be used to guide the user through the event organisation process.

Accordingly, at step 810 a user provides an indication of the selected event type, with this being used by the event server at step 815 to select an event template based on the event type.

At step 820, the event server 201 requests event requirements based on the event template. This may be achieved in any suitable manner, but typically involves displaying a webpage including fields defining relating to the event requirements that need to be defined, thereby prompting the user to supply the information needed to setup and run the event.

The user completes the event requirements at step 825, with these being received and reviewed by the event server 201 to whether the event requirements are completed at step 830. If not the process moves on to step 835, allowing the event server 201 to request further event requirements, for example by reloading the webpage with uncompleted fields highlighted, with this process being repeated until all events requirements are met.

Once all needed event requirements are defined, at step 840 the event server can operate to book venues and suppliers as required, using the processes described above, optionally preparing event information for publication or the like, at step 845. This can include creating a website, which can then be hosted by the event server 201, with the website being used to publicise the event, as well as accept bookings for attendees, or the like. Thus, this process can use defined templates allowing events such as conferences to be set and up and run, without requiring specialist knowledge of the user. In one example, this is performed as a wizard, with the user selecting options, allowing the event server 201 to ascertain requirements associated with the event, in turn allowing the event server 201 to book and run the event in a substantially automated fashion. This empowers unskilled individuals to organise events, such as conferences, including booking venues and required suppliers, thereby reducing reliance on consultants or the like.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. An apparatus for booking a venue for an event using a networked computer environment, the apparatus comprising:
a memory containing instructions which when executed by an electronic processing device comprise:
a) determining venue requirements;
b) determining venues matching the venue requirements by searching a database for venue details of multiple venues;
c) providing an indication of available venues to a display via a communications network;
d) determining a selection of an available venue from a venue booking request received from a user interface via the communications network; and
e) booking the selected venue by providing information regarding the selection of the available venue to a venue operator interface device.

2. The apparatus according to claim 1, wherein the venue requirements include:
a) a venue location;
b) an event volume; and
c) an event date.

3. The apparatus according to claim 2, wherein the electronic processing device determines venue requirements at least one of:
a) in accordance with user input commands received via the user interface; and
b) using event requirements defining an event.

4. The apparatus according to claim 3, wherein the memory contains instructions which when executed by an electronic processing device further comprises:
a) requesting venue requirements from the user interface via the communications network, the request including an indication of required venue requirements; and
b) receiving venue requirements from the user interface via the communications network.

5. The apparatus according to claim 4, wherein the memory contains instructions which when executed by an electronic processing device further comprises:
a) searching for suitable venues using the venue requirements; and
b) determining the availability of the suitable venues using a venue calendar associated with each venue.

6. The apparatus according to claim 5, wherein the memory contains instructions which when executed by an electronic processing device further comprises:
a) comparing the venue requirements to venue details; and
b) determining suitable venues in accordance with the results of the comparison.

7. The apparatus according to claim 6, wherein the memory contains instructions which when executed by an electronic processing device further comprises:
a) generating a list of available venues; and
b) transferring the list of available venues to the user interface via the communications network.

8. The apparatus according to claim 7, wherein the memory contains instructions which when executed by an electronic processing device further comprises, updating a calendar associated with the selected venue in response to an indication of a successful booking.

9. The apparatus according to claim 8, wherein, the memory contains instructions which when executed by an electronic processing device in response to an indication of successful booking comprises:
a) generating a venue booking confirmation; and
b) transferring the venue booking confirmation to the user interface via the communications network.

10. The apparatus according to claim 9, wherein the apparatus includes a venue electronic processing device associated with a respective venue, wherein the venue electronic processing device includes a memory containing instructions which when executed by the venue electronic processing device further comprises:
a) in response to user input commands, generating a venue booking request for the respective venue;
b) transferring the venue booking request to the electronic processing device, the electronic processing device being responsive to the venue booking request to:
i) confirm the respective venue is available; and
ii) in response to a successful confirmation, book the venue.

11. The apparatus according to claim 10, wherein the apparatus includes a database that stores venue details for a plurality of venues, the venue details including at least one of:
a) a venue location;
b) a venue size; and
c) a calendar indicative of venue availability.

12. The apparatus according to claim 11, wherein the memory contains instructions which when executed by an electronic processing device further comprises:
a) receiving venue details from a venue operator user interface device via the communications network; and
b) storing the venue details in the database.

13. The apparatus according to claim 12, wherein the memory contains instructions which when executed by an electronic processing device further comprises:
a) receiving a venue register request from the venue operator user interface via the communications network;
b) generating a venue details request; and
c) transferring the venue details request to the venue operator via the communications network, the venue details being received in response the venue details request.

14. A method for booking a venue for an event using a networked computer environment using an electronic processing device, the method comprising:
a) determining venue requirements;
b) determining venues matching the venue requirements by searching venue details of multiple venues;
c) providing an indication of available venues to a user interface device via the communications network;
d) determining selection of an available venue from a venue booking request received from the user interface via the communications network; and
e) booking the selected venue.

15. An apparatus for booking a supplier for an event using a networked computer environment, the apparatus including a memory containing instructions which when executed by an electronic processing device comprises:
a) determining supplier requirements;
b) determining suppliers matching the supplier requirements by searching supplier details of multiple suppliers;
c) providing an indication of available suppliers to a user interface device via the communications network;
d) determining selection of an available supplier from a supplier booking request received from the user interface device via the communications network; and
e) booking the selected supplier.

16. The apparatus according to claim 15, wherein the supplier requirements include:
a) a supplier location;
b) an event volume; and
c) an event date.

17. The apparatus according to claim 16, wherein the instructions which when executed by the electronic processing device further includes: determining supplier requirements at least one of:
a) in accordance with user input commands; and
b) using event requirements defining an event.

18. The apparatus according to claim 17, wherein the instructions which when executed by the electronic processing device further includes:
a) requesting supplier requirements from a user interface device via the communications network, the requesting including indicating required supplier requirements; and
b) receiving supplier requirements from the user interface device via the communications network.

19. The apparatus according to claim 18, wherein the instructions which when executed by the electronic processing device further includes:
a) searching for suitable suppliers using the supplier requirements; and
b) determining the availability of the suitable suppliers using a supplier calendar associated with each supplier to thereby determine the available suppliers.

20. The apparatus according to claim 19, wherein the instructions which when executed by the electronic processing device includes:
a) comparing the supplier requirements to supplier details; and
b) determining suitable suppliers in accordance with the results of the comparison.

21. The apparatus according to claim 20, wherein the instructions which when executed by the electronic processing device includes:
a) generating a list of available suppliers; and
b) transferring the list of available suppliers to the user interface device via the communications network.

22. The apparatus according to claim 21, wherein the instructions which when executed by the electronic processing device includes determining a user selection of one of the suppliers in accordance with user input commands received via the communications network.

23. The apparatus according to claim 22, wherein, in response to a successful booking, the instructions which when executed by the electronic processing device includes updating a calendar associated with the selected supplier.

24. The apparatus according to claim 23, wherein, in response to a successful booking, the instructions which when executed by the electronic processing device include:
a) generating a supplier booking confirmation; and
b) transferring the supplier booking confirmation to the user interface device via the communications network.

25. The apparatus according to claim 24, wherein the apparatus includes a database that stores supplier details for a plurality of suppliers, the supplier details including at least one of:
a) a supplier location;
b) a supplier size; and
c) a calendar indicative of supplier availability.

26. The apparatus according to claim 25, wherein the instructions which when executed by the electronic processing device further includes:
a) receiving supplier details from a supplier operator interface via the communications network; and
b) storing the supplier details in the database.

27. The apparatus according to claim 26, wherein the instructions which when executed by the electronic processing device further include:
a) receiving a supplier register request from the supplier operator interface device via the communications network;
b) generating a supplier details request; and
c) transferring the supplier details request to the supplier operator interface device via the communications network, the supplier details being received in response the supplier details request.

28. A method for organizing an event in a networked computer environment using an electronic processing device, the method comprises:
a) determining event requirements in response to an indication received from a user interface device;
b) determining venue requirements from the event requirements, wherein the venue requirements include a venue location, an event volume, and an event date;
c) using the venue requirements to book a venue;
d) determining supplier requirements from the event requirements, the supplier requirements including a supplier location, an event volume, and an event date;
e) using the supplier requirements to book a supplier by providing determined supplier requirements to a supplier interface device;
f) providing a venue and a supplier booking confirmation to a user interface device via the communications network; and
g) providing event information regarding the selection of the available venue to a venue operator interface device while simultaneously providing the determined supplier requirements to the supplier interface device.
